(19) United States
(12) Patent Application Publication
(10) Pub. No.: US 2003/0160197 A1
(43) Pub. Date: Aug. 28, 2003

(54) Solenoid-operated valve

(76) Inventor: Yuichi Kodama, Naka-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/357,458

(22) Filed: Feb. 4, 2003

(30) Foreign Application Priority Data
Feb. 6, 2002 (JP) 2002-029615

(51) Int. Cl. F16K 31/12

(52) U.S. Cl. 251/57; 251/129.2; 251/279; 251/129.16; 251/129.1

(57) ABSTRACT

A solenoid-operated valve which has, between a moving element operated by an electromagnetic force and a valve element, a displacement converting mechanism for increasing or decreasing a displaced amount of the valve element relative to a displaced amount of the moving element, or a force converting mechanism for increasing or decreasing a driving force of the valve element relative to a driving force of the moving element. This solenoid-operated valve can reduce power consumption because it changes the displaced amount or the driving force of the valve element with a simple structure.

### BACKGROUND OF THE INVENTION

1. Field of the Invention

The present invention relates to a solenoid-operated valve which operates a valve element by magnetism of an electromagnet, and more particularly to a solenoid-operated valve which changes a driving force of the valve element or a displaced amount of the valve element when the valve is opened.

2. Description of the Related Art

An internal combustion engine has an intake valve between a combustion chamber and an intake path and an exhaust valve between the combustion chamber and an exhaust path. When new gas is drawn into the combustion chamber, the intake valve is opened to draw the gas from the intake path into the combustion chamber. The exhaust valve is opened when the burnt gas is exhausted from the combustion chamber, and the gas is exhausted from the combustion chamber to the exhaust path. Thus, it is repeated that new as is drawn in and burnt in the combustion chamber of the internal combustion engine, and the burnt gas is discharged. The intake valve or the exhaust valve is actuated by a cam mechanism or an actuator.

Japanese Patent Application Laid-Open No. 58-183805 (hereinafter referred to as the “publication 1”) describes a solenoid-operated valve which drives a valve element by a solenoid actuator. The solenoid-operated valve has the valve element connected to one end of a plunger which is operated by magnetization of an electromagnet. The plunger is operated by the magnetization of the electromagnet, and the valve element is opened or closed.

Japanese Patent Application Laid-Open No. 2000-303809 (hereinafter referred to as the “publication 2”) describes a solenoid-operated valve of a type different from that of the publication 1. This solenoid-operated valve has an armature which is activated by an electromagnet, a zero-rush adjuster which is normally disposed between a cam and a tappet, and a valve element. And, the zero-rush adjuster is disposed between the armature and the valve element. The solenoid-operated valve of the publication 2 has the valve element operated by pressure oil and the electromagnet.

The combustion chamber in which a gas is combusted has a high pressure. A particularly large force is required when the exhaust valve is started to open. Therefore, it is necessary to increase a driving force for the valve element. The solenoid-operated valve of the publication 1 needs a large current in order to increase the driving force for the valve element. Therefore, there is a problem that power consumption becomes high. Attraction or repulsion of the electromagnet is in inverse proportion to the square of the distance between a coil and a magnetic substance. In other words, the attraction or repulsion of the electromagnet becomes smaller as the distance between the coil and the magnetic substance becomes larger. Therefore, when the solenoid-operated valve of the publication 1 has a large distance between the coil and the magnetic substance, a still larger current is required, and power consumption becomes high.

The solenoid-operated valve of the publication 2 has the electromagnet magnetized and the zero-rush adjuster supplied with the pressure oil, and the force which is applied by the hydraulic pressure is added to the attraction of the electromagnet. Therefore, the control of the hydraulic pressure enables to increase the driving force of the valve element. But, a hydraulic pressure control device is required to control the hydraulic pressure. But, the addition of the hydraulic pressure control device to the solenoid-operated valve has problems that the structure becomes complex, and the production cost increases.

Besides, it is desired that the above problems are remedied, and a displaced amount of the valve element is increased so to make a gas intake port and a gas exhaust port have large open areas.

The present invention was achieved under the circumstances described above, and it is an object of the present invention to provide a solenoid-operated valve which has a simple structure and reduces power consumption by varying a displaced amount or a driving force of the valve element.

### SUMMARY OF THE INVENTION

Accordingly, a first aspect of the present invention is directed to a solenoid-operated valve, comprising:

a moving element which is operated by an electromagnetic force;

a valve element which performs an opening or closing operation according to the operation of the moving element; and

a displacement converting mechanism which increases or decreases a displaced amount of the valve element relative to a displaced amount of the moving element.

The first aspect of the invention has the displacement converting mechanism, which increases or decreases a displaced amount of the valve element relative to a displaced amount of the moving element, between the moving element which is operated by the electromagnetic force and the valve element.

According to the first aspect of the invention, open areas of a gas intake port and a gas exhaust port can be varied.

A second aspect of the present invention is directed to a solenoid-operated valve, comprising:

a moving element which is operated By an electromagnetic force;

a valve element which performs an opening or closing operation according to the operation of the moving element; and

a displacement converting mechanism which has a moving element-side piston connected to the moving element, a valve element-side piston connected to the valve element, and a pressure chamber into which the moving element-side piston and the valve element-side piston are inserted, and which differentiates between a pressure-receiving area of the moving element-side piston and a pressure-receiving area of the valve element-side piston to increase or decrease a displaced amount of the valve element relative to a displaced amount of the moving element.

The second aspect of the present invention has the displacement converting mechanism, which increases or decreases a displaced amount of the valve element relative to a displaced amount of the moving element, between the moving element which is operated by the electromagnetic force and the valve element, and the displacement converting mechanism is provided with the moving element-side piston connected to the moving element, the valve element-side piston connected to the valve element, and the pressure chamber into which the respective pistons are inserted and oil, gas or the like is also sealed.

When the moving element-side piston has a large pressure-receiving area and the valve element-side piston has a small pressure-receiving area, the displaced amount of the valve element-side piston is increased as compared with the displaced amount of the moving element-side piston. When the moving element-side piston has a small pressure-receiving area and the valve element-side piston has a large pressure-receiving area, the displaced amount of the valve element-side piston is decreased as compared with the displaced amount of the moving element-side piston.

According to the second aspect of the present invention, open areas of the gas intake port and the gas exhaust port can be varied. And, the displaced amount of the valve element can be increased or decreased without flowing a large current. Further, because a hydraulic pressure control device or the like is not used, the structure is made simple and the production cost can be reduced.

A third aspect of the present invention is directed to a solenoid-operated valve, comprising:

a moving element which is operated by an electromagnetic force;

a valve element which performs an opening or closing operation according to the operation of the moving element; and

a displacement converting mechanism having a linkage pivotably disposed on the moving element, for applying a force to the valve element to thereby increases or decreases a displaced amount of the valve element relative to a displaced amount of the moving element.

The third aspect of the present invention has the displacement converting mechanism, which increases or decreases the displaced amount of the valve element relative to the displaced amount of the moving element, between the moving element operated by the electromagnetic force and the valve element, and the displacement converting mechanism has the linkage having a fulcrum, power point, point of action, and causes the moving element to contact to the power point and the valve element to contact to the point of action.

When the distance between the fulcrum and the point of action is larger than that between the fulcrum and the power point, the displaced amount of the valve element-side piston is increased as compared with the displaced amount of the moving element-side piston. When the distance between the fulcrum and the point of action is smaller than that between the fulcrum and the power point, the displaced amount of the valve element-side piston is decreased as compared with the displaced amount of the moving element-side piston.

According to the third aspect of the present invention, open areas of the gas intake port and the gas exhaust port can be varied. And, the displaced amount of the valve element can be increased or decreased without flowing a large current. Further, because a hydraulic pressure control device or the like is not used, the structure becomes simple and the production cost can be reduced.

A fourth aspect of the present invention is directed to a solenoid-operated valve, comprising:

a moving element which is operated by an electromagnetic force;

a valve element which performs an opening or closing operation according to the operation of the moving element; and

a force converting mechanism which has a moving element-side piston connected to the moving element, a valve element-side piston connected to the valve element, and a pressure chamber into which the moving element-side piston and the valve element-side piston are inserted, and which differentiates between a pressure-receiving area of the moving element-side piston and a pressure-receiving area of the valve element-side piston to increase or decrease a driving force of the valve element relative to a driving force of the moving element.

The fourth aspect of the present invention has the force converting mechanism, which increases or decreases a driving force of the valve element relative to a driving force of the moving element, between the moving element which is moved by an electromagnetic force and the valve element, and the force converting mechanism is provided with the moving element-side piston connected to the moving element, the valve element-side piston connected to the valve element, and a pressure chamber into which the respective pistons are inserted and oil, gas or the like is also sealed.

When the moving element-side piston has a large pressure-receiving area and the valve element-side piston has a small pressure-receiving area, the driving force of the valve element-side piston is decreased as compared with the driving force of the moving element-side piston. When the moving element-side piston has a small pressure-receiving area and the valve element-side piston has a large pressure-receiving area, the driving force of the valve element-side piston is increased as compared with the driving force of the moving element-side piston.

According to the fourth aspect of the present invention, the driving force of the valve element can be increased or decreased without flowing a large current. Further, because a hydraulic pressure control device or the like is not used, the structure becomes simple and the production cost can be reduced.

A fifth aspect of the present invention is directed to a solenoid-operated valve, comprising:

a moving element which is operated by an electromagnetic force;

a valve element which performs an opening or closing operation according to the operation of the moving element; and

a force converting mechanism having a linkage pivotably disposed on the moving element, for applying a force to the valve element to thereby increases or decreases a driving force of the valve element relative to a driving force of the moving element.

The fifth aspect of the present invention is provided with the force converting mechanism, which increases or decreases a driving force of the valve element relative to a driving force of the moving element, between the moving element which is operated by an electromagnetic force and the valve element, and the force converting mechanism is provided with the linkage having a fulcrum, power point, point of action and causes the moving element to contact to the power point so to cause the valve element to contact to the point of action.

When the distance between the fulcrum and the point of action is larger than that between the fulcrum and the power point, the driving force of the valve element-side piston is decreased as compared with the driving force of the moving element-side piston. When the distance between the fulcrum and the point of action is smaller than that between the fulcrum and the power point, the driving force of the valve element-side piston is increased as compared with the driving force of the moving element-side piston.

According to the fifth aspect of the present invention, the driving force of the valve element can be increased or decreased without flowing a large current. Further, because a hydraulic pressure control device or the like is not used, the structure becomes simple and the production cost can be reduced.

### BRIEF DESCRIPTION OF THE DRAWINGS

FIGS. 1A to 1C are structure diagrams showing a solenoid-operated valve 10 of a first embodiment of the present invention;

FIGS. 2A to 2C are diagrams showing cylinders 26, 26′ of a solenoid-operated valve 20 of a second embodiment of the present invention;

FIGS. 3A to 3C are diagrams showing a cylinder 36 of a solenoid-operated valve 30 of a third embodiment of the present invention;

FIGS. 4A to 4C are structure diagrams showing a solenoid-operated valve 40 of a fourth embodiment of the present invention;

FIGS. 5A to 5C are structure diagrams showing a solenoid-operated valve 50 of a fifth embodiment of the present invention;

FIGS. 6A to 6C are structure diagrams showing a solenoid-operated valve 60 of an embodiment different from the solenoid-operated valve 50 of the present invention;

FIG. 7 is a diagram illustrating a solenoid-operated valve 90 of a sixth embodiment of the present invention;

FIGS. 8A to 8C are structure diagrams showing a solenoid-operated valve 70 of a seventh embodiment of the present invention;

FIGS. 9A to 9C are diagrams showing a “fulcrum”, a “power point” and a “point of action” in the states of FIGS. 8A to 8C on the same linear line by projecting them in an operating direction of the valve element; and

FIGS. 10A and 10B are diagrams illustrating the principle of operation of the solenoid-operated valve 10.

### DETAILED DESCRIPTION OF THE PREFERRED EMBODIMENTS

Embodiments of the present invention will be described with reference to the accompanying drawings. It is assumed that the respective solenoid-operated valves to be described below are used as exhaust valves, but they can also be used as intake valves.

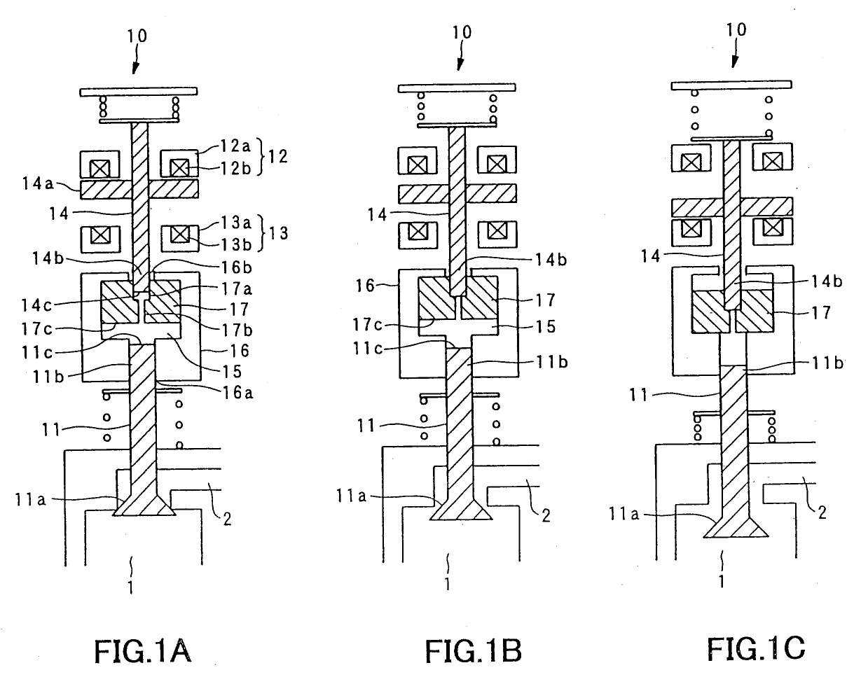

FIGS. 1A to 1C are structure diagrams showing the solenoid-operated valve 10 of the first embodiment of the present invention. FIGS. 1A to 1C sequentially show a valve opening operation of the solenoid-operated valve 10.

The principle of operation of the solenoid-operated valve 10 will be described before describing its structure and action.

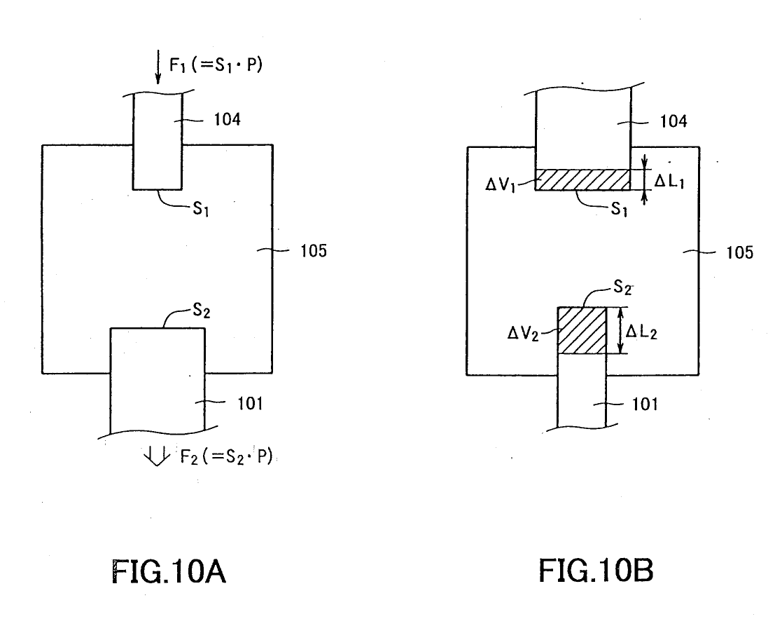

FIGS. 10A and 10B are diagrams illustrating the principle of operation of the solenoid-operated valve 10.

As shown in FIG. 10A, it is assumed that a hydraulic chamber 105 has a hydraulic pressure P, a piston on the side of an armature 104 has a pressure-receiving area S1, a piston on the side of a valve element 101 has a pressure-receiving area S2, and the armature 104 is forced into the hydraulic chamber. A force required for pushing the armature 104 into the hydraulic chamber 105, namely a driving force of the armature 104, is F1=S1·P. When the armature 104 is forced into the hydraulic chamber 105, the valve element 101 is forced out of the hydraulic chamber 105. At this time, force F2=S2·P acts on the valve element 101. Therefore, when it is desired to have F1<F2, it may be set to S1·P<S2·P, namely S1<S2.

As shown in FIG. 10B, it is assumed that the armature 104 is forced into the hydraulic chamber 105, the piston on the side of the armature 104 has a displaced amount ΔL1 and the piston on the side of the valve element 101 has a displaced amount ΔL2. Then, the armature 104 in the hydraulic chamber 105 has a volume increment of ΔV1=L1·S1, and the valve element 101 in the hydraulic chamber 105 has a volume decrement of ΔV2=ΔL2·S2. When the hydraulic chamber 105 is closed airtight, a volume V of the pressure oil is constant, establishing a relationship of ΔV1=ΔV2, namely ΔL1·S1=ΔL2·S2. Therefore, when it is desired to have ΔL1<ΔL2, it may be determined as S2<S1.

Thus, when S1<S2 is determined, F1<F2 and ΔL1>ΔL2 are provided, and when S1>S2 is determined, F1>F2 and ΔL1<ΔL2 are provided.

The present invention increases a driving force of the valve element when the valve is opened with a high inside pressure of the combustion chamber and increases a displaced amount of the valve element when the inside pressure of the combustion chamber decreases after the valve is opened. The solenoid-operated valve 10 according to the first embodiment is designed to have a pressure-receiving area of each piston in such a way that the driving force of the valve element is increased when the valve is opened and the displaced amount of the valve element is increased after the valve is opened. The solenoid-operated valve 10 will be described below.

The solenoid-operated valve 10 comprises a valve element 11 which communicates a combustion chamber 1 and an exhaust path 2 according to the valve opening operation and separates them according to the valve closing operation, a ring electromagnet 12, a circular ring electromagnet 13 which is disposed to face the ring electromagnet 12, an armature 14 which is operated by magnetization of the electromagnets 12, 13, and a cylinder 16 which is disposed between the valve element 11 and the armature 14 to give or receive a force between the valve element 11 and the armature 14 through the pressure oil of a hydraulic chamber 15.

The valve element 11 has a lid 11a which is disposed at the joint between the combustion chamber 1 and the exhaust path 2 and a valve element-side piston 11b which operates in the hydraulic chamber 15. The valve element-side piston 11b receives the hydraulic pressure of the hydraulic chamber 15 by a pressure-receiving section 11c. Accordingly, the force of pressure oil of the hydraulic chamber 15 acts on the valve element 11. The valve element 11 is kept forced toward the cylinder 16 by a spring.

The electromagnet 12 comprises a circular ring magnetic substance 12a and a coil 12b which is disposed in the magnetic substance 12a. Similarly, the electromagnet 13 comprises a circular ring magnetic substance 13a and a coil 13b which is disposed in the magnetic substance 13a.

The armature 14 has a circular plate 14a which is disposed between the electromagnet 12 and the electromagnet 13 and an armature-side piston 14b which operates in the hydraulic chamber 15 and has a diameter smaller than that of the valve element-side piston 11b. The plate 14a is a magnetic substance which is attracted by the electromagnet 12 when a current is flown to the coil 12b and attracted by the electromagnet 13 when the current is flown to the coil 13b. The armature-side piston 14b receives the hydraulic pressure of the hydraulic chamber 15 by a pressure-receiving section 14c which has a pressure-receiving area smaller than that of the pressure-receiving section 11c of the valve element-side piston 11b. Therefore, the attraction of the electromagnet 12 or the electromagnet 13 and the force by the pressure oil of the hydraulic chamber 15 act on the armature 14. And the armature 14 is kept forced toward the cylinder 16 by a spring.

The cylinder 16 has a valve element sliding hole 16a through which the valve element-side piston 11b slides, an armature sliding hole 16b through which the armature-side piston 14b slides, and the hydraulic chamber 15. The valve element sliding hole 16a and the armature sliding hole 16b are communicated with the hydraulic chamber 15, and the valve element-side piston 11b and the armature-side piston 14b slide the holes 16a and 16b, respectively. A large piston 17, which slides upward in the drawing, namely toward the armature 14 (hereinafter referred to as the “upward”), and downward in the drawing, namely toward the valve element 11 (hereinafter referred to as the “downward”), is disposed in the hydraulic chamber 15.

A large-diameter hole 17a which has the same diameter as that of the armature sliding hole 16b and in which the armature-side piston 14b is freely slidable is disposed above the large piston 17, and a small-diameter hole 17b having a diameter smaller than that of the large-diameter hole 17a is disposed below the large piston 17. The large-diameter hole 17a and the small-diameter hole 17b are mutually communicated. The large piston 17 receives the hydraulic pressure of the hydraulic chamber 15 by a pressure-receiving section 17c which has a pressure-receiving area larger than that of the pressure-receiving section 11c of the valve element-side piston 11b.

Then, the operation of the solenoid-operated valve 10 will be described with reference to FIGS. 1A to 1C.

When the current to the coil 13b is interrupted and the current is flown to the coil 12b, the plate 14a of the armature 14 is attracted by the electromagnet 12. Because the attraction of the electromagnet 12 is larger than the spring force acting on the armature 14, the plate 14a comes into contact with the electromagnet 12. At this time, the large piston 17 receives the hydraulic pressure of the hydraulic chamber 15 and is positioned at the upper stroke end. The valve element 11 is positioned at the upper stroke end by the spring force. At this time, the lid 11a of the valve element 11 separates the combustion chamber 1 and the exhaust path 2. This state is shown in FIG. 1A.

When the current to the coil 12b is interrupted and the current is flown to the coil 13b, the plate 14a of the armature 14 is attracted by the electromagnet 13. Therefore, the armature 14 is moved downward, and the armature-side piston 14b is forced into the large-diameter hole 17a of the large piston 17. The operation of the armature-side piston 14b transmits the driving force of the armature 14 to the valve element 11 through the pressure oil of the hydraulic chamber 15. Thus, the valve element-side piston 11b is forced out of the hydraulic chamber 15. Then, the lid 11a of the valve element 11 is moved downward to allow the communication of the combustion chamber 1 and the exhaust path 2. Further downward movement of the armature 14 makes the pressure-receiving section 14c come into contact with the end of the large-diameter hole 17a. This state is shown in FIG. 1B.

From the instant when the armature-side piston 14b starts to move from the upper stroke end to the instant when it reaches the end of the large-diameter hole 17a, the pressure oil of the hydraulic chamber 15 is pushed by the pressure-receiving section 14c of the armature-side piston 14b. This pressure oil pushes the pressure-receiving section 11c of the valve element-side piston 11b. The pressure-receiving area of the pressure-receiving section 11c is larger than that of the pressure-receiving section 14c, so that a displaced amount of the valve element 11 becomes smaller than that of the armature 14. Meanwhile, the force which is transmitted from the armature-side piston 14b to the valve element-side piston 11b through the pressure oil becomes large. In other words, the driving force of the valve element 11 becomes larger than that of the armature 14.

When the pressure-receiving section 14c of the armature 14 reaches the end of the large-diameter hole 17a, the armature 14 and the large piston 17 become integral. And, when the armature-side piston 14b moves downward, the large piston 17 makes the hydraulic chamber 15 slide downward, and the valve element-side piston 11b is moved downward. Thus, the respective pistons 11b, 14b, 17 are moved to reach the lower stroke ends. This state is shown in FIG. 1C.

Until the armature-side piston 14b reaches from the end of the large-diameter hole 17a to the lower stroke end, the pressure oil of the hydraulic chamber 15 is pushed by the pressure receiving section 14c of the armature-side piston 14b and the pressure-receiving section 17c of the large piston 17, and the pressure-receiving section 11c of the valve element-side piston 11b is pushed by the pressure oil. Because pressure-receiving area of the pressure-receiving section 11c is smaller than that of the pressure-receiving section 17c, the displaced amount of the valve element 11 becomes larger than that of the armature 14. Meanwhile, the force which is transmitted from the armature-side piston 14b to the valve element-side piston 11b through the pressure oil becomes small. In other words, the driving force of the valve element 11 becomes smaller than that of the armature 14.

The solenoid-operated valve 10 can make the driving force of the valve element 11 larger than that of the armature 14 without flowing a large current when the valve is opened with a high inside pressure of the combustion chamber 1. Thus, the opening operation of the valve element 11 can be made smoothly. The displaced amount of the valve element 11 can be made larger than that of the armature 14 without flowing a large current after the inside pressure of the combustion chamber 1 is decreased, so that a gas intake port and a gas exhaust port have large open areas. The solenoid-operated valve 10 has a simple structure because a hydraulic pressure control device or the like is not used, and its production cost can be reduced.

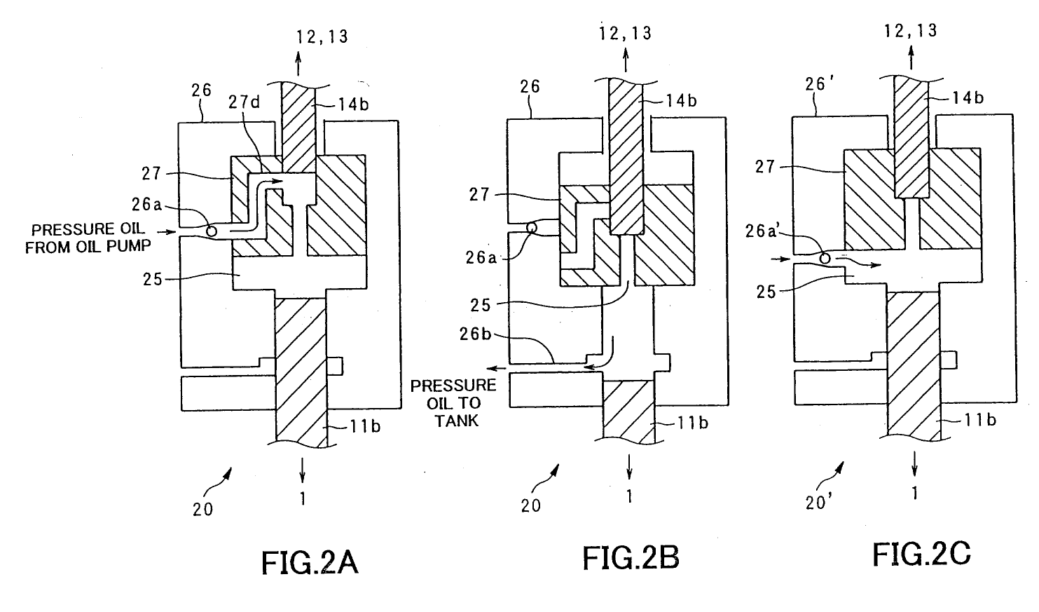

FIGS. 2A, 2B are diagrams showing a cylinder 26 of a solenoid-operated valve 20 according to the second embodiment of the present invention. FIG. 2A is a diagram showing a state that the armature-side piston 14b, a large piston 27 and the valve element-side piston 11b are positioned at the upper stroke ends, and the pressure oil has a small volume. FIG. 2B is a diagram showing a state that the armature-side piston 14b, the large piston 27 and the valve element-side piston 11b are positioned at the lower stroke ends, and the pressure oil has a large volume. In the solenoid-operated valve 20, the cylinder 26 is used instead of the cylinder 16 of the solenoid-operated valve 10. FIGS. 2A to 2C show only portions different from those of the solenoid-operated valve 10.

A hydraulic chamber 25 of the cylinder 26 is provided with the large piston 27 which slides up and down. As shown in FIG. 2A, the large piston 27 is provided with an oil passage 27d which communicates with the hydraulic chamber 25 when the armature-side piston 14b is positioned at the upper stroke end. Besides, the cylinder 26 is provided with a check valve 26a, which communicates the oil passage 27d and an output port when the large piston 27 reaches the upper stroke end, and an oil passage 26b, which communicates with the hydraulic chamber 25 when the valve element-side piston 11b reaches the lower stroke end. The input port of the check valve 26a and the oil passage 26b are communicated with an unshown oil pump. Generally, an engine is provided with an oil pump for lubrication.

If the pressure oil leaks, resulting in decreasing the volume of the hydraulic chamber 25, the pressure of the oil from the oil pump becomes larger than that of the hydraulic chamber 25, so that the check valve 26a is opened to flow the pressure oil from the oil pump into the hydraulic chamber 25. The check valve 26a is closed when the pressure of the oil from the oil pump becomes equal to that of the hydraulic chamber 25, and the pressure oil is stopped from flowing into the hydraulic chamber 25.

When the volume of the hydraulic chamber 25 is increased by the thermal expansion of the pressure oil, the valve element 11 is excessively pushed out, so that the tank and the hydraulic chamber 25 are mutually communicated through the oil passage 26b, and the pressure oil flows from the hydraulic chamber 25 to the tank. The valve element-side piston 11b is pushed upward as the pressure oil decreases. Then, the oil passage 26b is closed to stop the pressure oil from flowing to the tank.

Thus, a change in volume of the pressure oil resulting from the leakage or thermal expansion can be absorbed by the cylinder 26.

As shown in FIG. 2C, a cylinder 26′ may be provided with a check valve 26a′ so to communicate the hydraulic chamber 25 and the tank when the large piston 27 is positioned at the upper stroke end.

The solenoid-operated valves 10, 20 have the valve element-side piston 11b, the armature-side piston 14b and the large piston 17 disposed on the same axis, but the respective pistons may not be disposed on the same axis. For example, it may be configured so that the armature-side piston and the valve element-side piston operate in directions so that they intersect mutually at right angles. It may also be configured that the armature-side piston and the valve element-side piston are changed their axes so that they operate in parallel directions. As its example, a solenoid-operated valve 30 not having the respective pistons on the same axis will be described below.

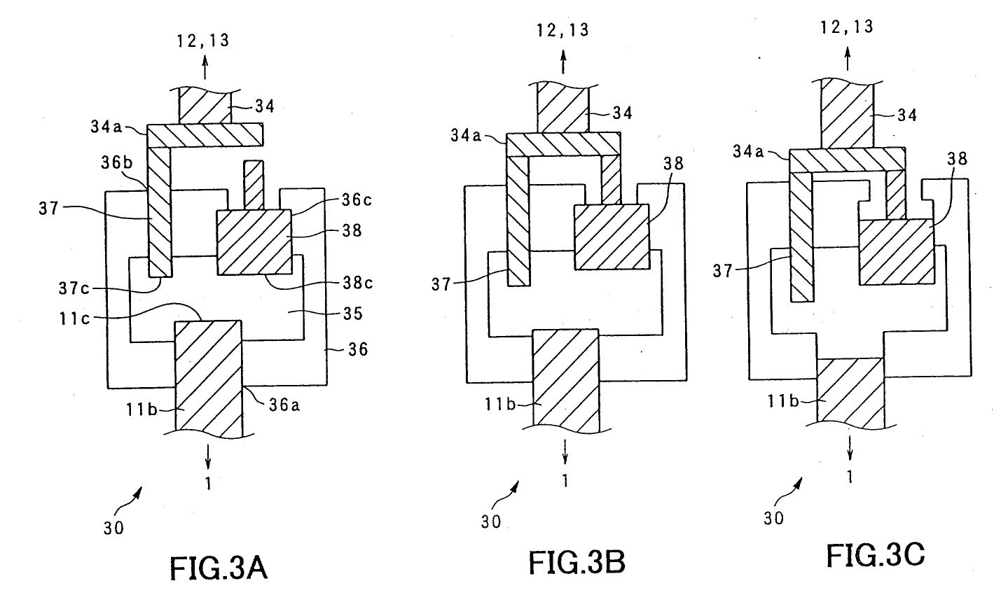

FIGS. 3A to 3C are diagrams showing a cylinder 36 of the solenoid-operated valve 30 according to the third embodiment of the present invention. FIGS. 3A to 3C show sequentially a valve opening operation of the solenoid-operated valve 30. The solenoid-operated valve 30 uses the cylinder 36 instead of the cylinder 16 of the solenoid-operated valve 10. FIGS. 3A to 3C show only portions different from the solenoid-operated valve 10. The principle of operation of the solenoid-operated valve 30 is-the same as that of the solenoid-operated valve 10.

The cylinder 36 has a valve element sliding hole 36a in which the valve element-side piston 11b slides, a first piston sliding hole 36b in which a first piston 37 slides, a second piston sliding hole 36c in which a second piston 38 slides, and a hydraulic chamber 35. The valve element sliding hole 36a, the first piston sliding hole 36b and the second piston sliding hole 36c are communicated with the hydraulic chamber 35. And, the valve element-side piston 11b, the first piston 37 and the second piston 38 respectively slide in the above sliding holes. The pressure-receiving area of the pressure-receiving section 11c of the valve element-side piston 11b is larger than that of a pressure-receiving section 37c of the first piston 37 and smaller than that of a pressure-receiving section 38c of the second piston 38.

The first piston 37 and the second piston 38, which move up and down, are partly protruded from the cylinder 36. One end of the first piston 37 is connected to an end 34a of an armature 34. And, the downward movement of the armature 34 makes one end of the second piston 38 come into contact with the end 34a of the armature 34. The first piston 37 receives a hydraulic pressure of the hydraulic chamber 35 by a pressure-receiving section 37c. The second piston 38 receives a hydraulic pressure of the hydraulic chamber 35 by the pressure receiving section 38c.

An operation of the solenoid-operated valve 30 will be described with reference to FIGS. 1A to 1C and FIGS. 3A to 3C.

When a current to the coil 13b is interrupted and a current is flowing to the coil 12b, the armature 34 is positioned at the upper stroke end in the same way as the solenoid-operated valve 10 shown in FIG. 1A. At this time, the first piston 37, the second piston 38 and the valve element-side piston 11b are poisoned at the upper stroke ends. This state is shown in FIG. 3A.

When a current to the coil 12b is interrupted and a current is flowing to the coil 13b, the armature 34 is moved downward in the same way as the solenoid-operated valve 10 shown in FIG. 1B, so that the first piston 37 is forced into the hydraulic chamber 35. The operation of the first piston 37 transmits the driving force of the armature 34 to the valve element 11 through the pressure oil of the hydraulic chamber 35. Then, the valve element-side piston 11b is pushed out of the hydraulic chamber 35. Therefore, the lid 11a of the valve element 11 is operated to communicate the combustion chamber 1 and the exhaust path 2.

When the armature 34 is moved downward, the end 34a comes to reach the second piston 38. This state is shown in FIG. 3B.

From the instant when the end 34a of the armature 34 starts to operate from the upper stroke end to the instant when it reaches the second piston 38, the pressure oil of the hydraulic chamber 35 is pushed by the pressure-receiving section 37c of the first piston 37, and the pressure-receiving section 11c of the valve element-side piston 11b is pushed by the pressure oil. A pressure-receiving area of the pressure-receiving section 11c is larger than that of the pressure-receiving section 37c, so that a displaced amount of the valve element 11 becomes smaller than that of the armature 34. Meanwhile, the force which is transmitted from the first piston 37 to the valve element-side piston 11b through the pressure oil becomes large. In other words, the driving force of the valve element 11 becomes larger than that of the armature 34.

When the end 34a of the armature 34 comes into contact with the second piston 38, the armature 34, the first piston 37 and the second piston 38 become integral. And, the first piston 37 and the second piston 38 are moved downward with the downward movement of the armature 34. Thus, the respective pistons 11b, 37, 38 are moved to reach the lower stroke ends. This state is shown in FIG. 3C.

From the instant when the end 34a of the armature 34 comes into contact with the second piston 38 to the instant when it reaches the lower stroke end, the pressure oil of the hydraulic chamber 35 is pushed by the pressure-receiving section 37c of the first piston 37 and the pressure-receiving section 38c of the second piston 38. And, the pressure-receiving section 11c of the valve element-side piston 11b is pushed by the pressure oil. The pressure-receiving area of the pressure-receiving section 11c is smaller than a total area of the pressure-receiving area of the pressure-receiving section 37c and that of the pressure-receiving section 38c, so that the displaced amount of the valve element 11 becomes larger than that of the armature 34. Meanwhile, the force which is transmitted from the first piston 37 and the second piston 38 to the valve element-side piston 11b through the pressure oil becomes small. In other words, the driving force of the valve element 11 becomes smaller than that of the armature 34.

By the solenoid-operated valve 30, the driving force of the valve element 11 can be made larger than that of the armature 34 without flowing a large current when the valve is opened with a high inside pressure of the combustion chamber 1, and the valve opening operation of the valve element 11 is performed smoothly. And, the displaced amount of the valve element 11 can be made larger than that of the armature 34 without flowing a large current after the inside pressure of the combustion chamber 1 is decreased, so that the gas intake port and the gas exhaust port have large open areas. And, the solenoid-operated valve 30 can have a simple structure because it does not use a hydraulic pressure control device or the like, and its production cost can be lowered.

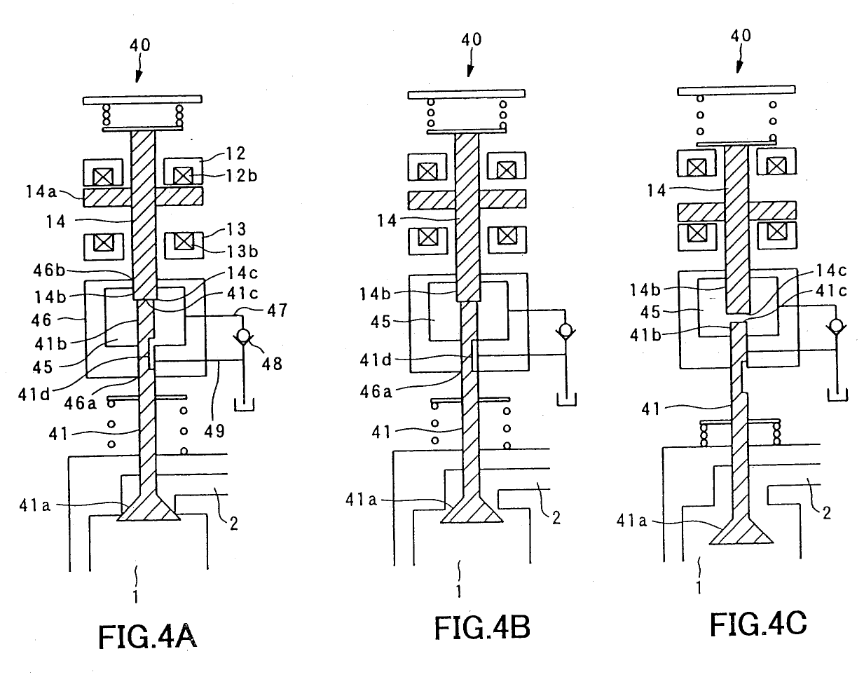

FIGS. 4A to 4C are structure diagrams showing a solenoid-operated valve 40 according to the fourth embodiment of the present invention. FIGS. 4A to 4C show sequentially a valve opening operation of the solenoid-operated valve 40. Like reference numerals are used to indicate like components as those used for the solenoid-operated valve 10 shown in FIG. 1. And, the solenoid-operated valve 40 is on the same principle of operation as that of the solenoid-operated valve 10.

A valve element 41 has a lid 41a which is disposed at a joint of the combustion chamber 1 and the exhaust path 2, a valve element-side piston 41b which operates in a hydraulic chamber 45 of a cylinder 46, and a notch 41d on its side. The pressure-receiving area of a pressure-receiving section 41c of the valve element-side piston 41b is smaller than that of the pressure-receiving section 14c of the armature-side piston 14b.

The cylinder 46 has a valve element sliding hole 46a in which the valve element-side piston 41b slides, an armature sliding hole 46b in which the armature-side piston 14b slides, and the hydraulic chamber 45. The valve element sliding hole 46a and the armature sliding hole 46b are communicated with the hydraulic chamber 45 and make the valve element-side piston 41b and the armature-side piston 14b slide therein. The hydraulic chamber 45 is communicated with an output port of a check valve 48 through an oil passage 47, and the check valve 48 has an input port which is communicated with a tank through an oil passage 49. And, the valve element sliding hole 46a is communicated with the tank through the oil passage 49.

Then, an operation of the solenoid-operated valve 40 will be described with reference to FIGS. 4A to 4C.

When a current to the coil 13b is interrupted and a current is flown to the coil 12b, the valve element 41 is positioned at the upper stroke end. At this time, the lid 41a of the valve element 41 interrupts the combustion chamber 1 and the exhaust path 2. Besides, the pressure-receiving section 14c of the armature-side piston 14b and the pressure-receiving section 41c of the valve element-side piston 41b come into contact with each other, and the hydraulic chamber 45 and the oil passage 49 are mutually communicated through the notch 41d and the valve element sliding hole 46a. Therefore, the hydraulic chamber 45 and the tank are mutually communicated. This state is shown in FIG. 4A.

When a current to the coil 12b is interrupted and a current is flown to the coil 13b, the armature 14 is moved downward, and the armature-side piston 14b is forced into the hydraulic chamber 45. At this time, the hydraulic chamber 45 is communicated with the tank. Therefore, the hydraulic pressure of the hydraulic chamber 45 can be disregarded, the armature-side piston 14b and the valve element-side piston 41b are integrally moved, and the valve element-side piston 41b is pushed out of the hydraulic chamber 45. Thus, the lid 41a of the valve element 41 is moved downward, and the combustion chamber 1 is communicated with the exhaust path 2.

When the valve element 41 is moved downward, an open area of the notch 41d in the hydraulic chamber 45 is gradually narrowed and closed as the valve element 41 is moving downward. Then, the hydraulic chamber 45 and the tank are interrupted. This state is shown in FIG. 4B.

When the notch 41d is closed, the hydraulic chamber 45 is closed tightly. Then, the pressure oil of the hydraulic chamber 45 is pushed by the pressure-receiving section 14c of the armature-side piston 14b with the movement of the armature 14. The pressure-receiving section 41c of the valve element-side piston 41b is pushed by the pressure oil. Because the pressure-receiving area of the pressure-receiving section 41c is smaller than that of the pressure-receiving section 14c, the displaced amount of the valve element 41 becomes larger than that of the armature 14. Meanwhile, the force to be transmitted from the armature-side piston 14b to the valve element-side piston 41b through the pressure oil becomes small. In other words, the driving force of the valve element 41 becomes smaller than that of the armature 14. Thus, the respective pistons 41b, 14b are moved to reach the respective lower stroke ends. This state is shown in FIG. 4C.

The solenoid-operated valve 40 can make the displaced amount of the valve element 41 larger than that of the armature 14 without flowing a large current after the inside pressure of the combustion chamber 1 is lowered, so that open areas of the gas intake port and the gas exhaust port become large. And, the solenoid-operated valve 40 has a simple structure and its production cost can be reduced because it does not have a hydraulic pressure control device or the like.

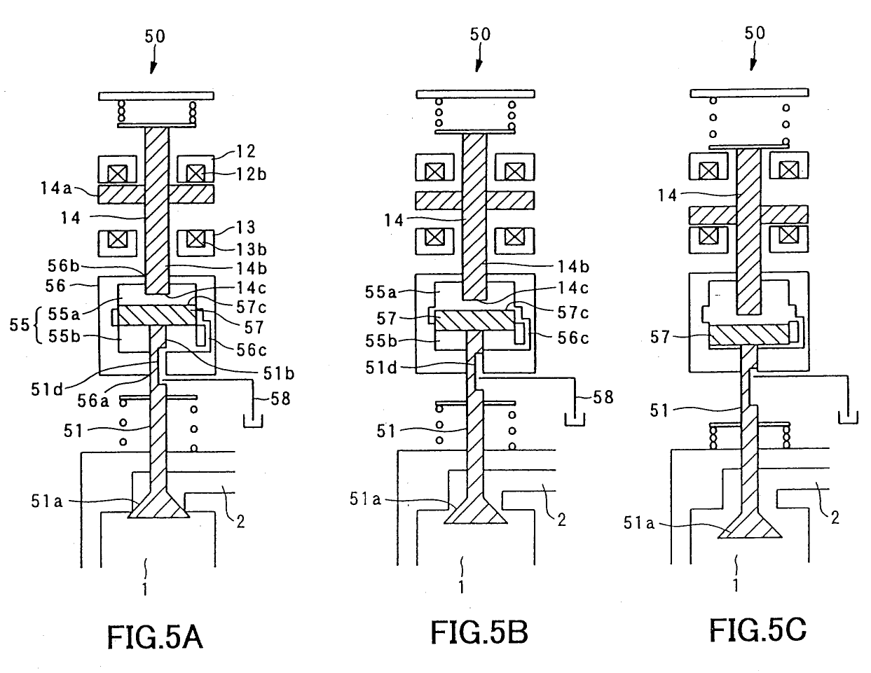

FIGS. 5A to 5C are structure diagrams showing a solenoid-operated valve 50 according to the fifth embodiment of the present invention. FIGS. 5A to 5C show sequentially a valve opening operation of the solenoid-operated valve 50. Like reference numerals are used to indicate like components as those used for the solenoid-operated valve 10 shown in FIG. 1 or the solenoid-operated valve 40 shown in FIG. 4. And, the solenoid-operated valve 50 is on the same principle of operation as that of the solenoid-operated valve 10.

A valve element 51 has a lid 51a which is disposed at the joint of the combustion chamber 1 and the exhaust path 2, and a valve element-side piston 51b which operates in a hydraulic chamber 55 of a cylinder 56. The cross-sectional area of the valve element-side piston in its diameter direction is smaller than the pressure-receiving area of the pressure-receiving section 14c of the armature-side piston 14b. And, the valve element 51 has a notch 51d on its side.

The cylinder 56 has a valve element sliding hole 56a in which the valve element-side piston 51b slides, an armature sliding hole 56b in which the armature-side piston 14b slides, and the hydraulic chamber 55. The hydraulic chamber 55 is provided with a large piston 57 which becomes integral with the valve element-side piston 51b and slides together in the hydraulic chamber 55. A portion of the hydraulic chamber 55 above the large piston 57 is a first hydraulic chamber 55a, and a portion of the hydraulic chamber 55 below the large piston 57 is a second hydraulic chamber 55b. The second hydraulic chamber 55b is communicated with an oil passage 56c, and the oil passage 56c is communicated with or interrupted from the first hydraulic chamber 55a by the operation of the large piston 57. The large piston 57 receives the hydraulic pressure of the first hydraulic chamber 55a by a pressure-receiving section 57c which has a pressure-receiving area larger than that of the pressure-receiving section 14c of the armature-side piston 14b. And, the valve element sliding hole 56a is communicated with the tank through an oil passage 58.

Then, an operation of the solenoid-operated valve 50 will be described with reference to FIGS. 5A to 5C.

When a current to the coil 13b is interrupted and a current is flowing to the coil 12b, the valve element 51 is positioned at the upper stroke end. Then, the lid 51a of the valve element 51 interrupts the combustion chamber 1 and the exhaust path 2. And, the second hydraulic chamber 55b and the oil passage 58 are mutually communicated by the notch 51d and the valve element sliding hole 56a. Therefore, the second hydraulic chamber 55b and the tank are mutually communicated. The first hydraulic chamber 55a and the oil passage 56c are interrupted by the large piston 57. This state is shown in FIG. 5A.

When a current to the coil 12b is interrupted and a current is flowing to the coil 13b, the armature 14 is moved downward, and the armature-side piston 14b is forced into the first hydraulic chamber 55a. The driving force of the armature 14 is transmitted to the large piston 57 and the valve element 51 by the operation of the armature-side piston 14b through the pressure oil of the first hydraulic chamber 55a. Then, the valve element-side piston 51b is pushed out of the second hydraulic chamber 55b. Thus, the lid 51a of the valve element 51 is moved downward, and the combustion chamber 1 and the exhaust path 2 are communicated with each other.

When the valve element 51 is moved downward, an open area of the notch 51d in the second hydraulic chamber 55b is gradually narrowed and closed when the valve element 51 is moving. Then, the second hydraulic chamber 55b and the tank are interrupted. At the same time, the first hydraulic chamber 55a and the oil passage 56c are mutually communicated. This state is shown in FIG. 5B.

From the instant when the armature-side piston 14b starts to move from the upper stroke end to the instant when the notch 51d of the valve element 51 is closed, the pressure oil is pushed by pressure-receiving section 14c of the armature-side piston 14b, and the pressure-receiving section 57c of the large piston 57 is pushed by the pressure oil. Because the pressure-receiving area of the pressure-receiving section 57c is larger than that of the pressure-receiving section 14c, the displaced amount of the valve element 51 becomes smaller than that of the armature 14. Meanwhile, the force which is transmitted from the armature-side piston 14b to the large piston 57 and the valve element-side piston 51b through the pressure oil becomes large. In other words, the driving force of the valve element 51 becomes larger than that of the armature 14.

When the first hydraulic chamber 55a and the second hydraulic chamber 55b are communicated with each other and the hydraulic chamber 55 is closed tightly, the large piston 57 receives the hydraulic pressures of the same pressure level from the first hydraulic chamber 55a and the second hydraulic chamber 55b. Therefore, the pressure-receiving area of the pressure-receiving section 57c of the large piston 57 becomes substantially equal to the cross-sectional area of the valve element 51. And, the large piston 57 is slid downward with the downward movement of the armature-side piston 14b, and the valve element-side piston 51b is moved downward. Thus, the respective pistons 14b, 51b, 57 are moved to reach the stroke ends. This state is shown in FIG. 5C.

From the instant when the communication between the notch 51d of the valve element 51 and the second hydraulic chamber 55b is interrupted to the instant when the valve element 51 reaches the lower stroke end, the pressure oil of the hydraulic chamber 55 is pushed by the pressure-receiving section 14c of the armature-side piston 14b and in turn pushes the pressure-receiving section 57c of the large piston 57 by a portion corresponding to the cross-sectional area of the valve element-side piston 51b. The displaced amount of the valve element 51 becomes larger than that of the armature 14 because the cross-sectional area of the valve element-side piston 51b is smaller than that of the pressure receiving section 14c. Meanwhile, the force which is transmitted from the armature-side piston 14b to the valve element-side piston 51b through the pressure oil becomes small. In other words, the driving force of the valve element 51 becomes smaller than that of the armature 14.

The solenoid-operated valve 50 can make the driving force of the valve element 51 larger than that of the armature 14 without flowing a large current when the valve is open with a high inside pressure of the combustion chamber 1, so that a valve opening operation of the valve element 51 can be made smoothly. And, the displaced amount of the valve element 51 can be made larger than that of the armature 14 without flowing a large current after the inside pressure of the combustion chamber 1 is decreased, so that the gas intake port and the gas exhaust port have large open areas. And, the solenoid-operated valve 50 has a simple structure and its production cost can be reduced because it does not use a hydraulic pressure control device or the like.

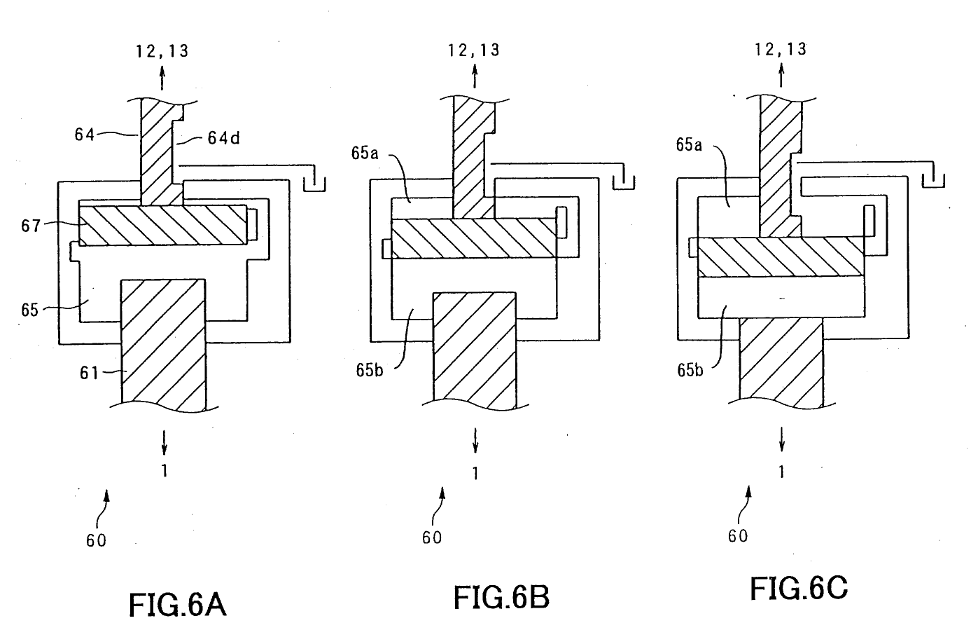

The solenoid-operated valve 60 shown in FIGS. 6A to 6C may have a force/displacement increasing mechanism which has a reverse structure of that of the solenoid-operated valve 50 shown in FIG. 5. Specifically, it can be configured in such a way that an armature 64 and a large piston 67 are made integral so to make a cross-sectional area of the armature 64 smaller than the pressure-receiving area of the valve element 61, and a notch 64d is formed on the armature 64 so to communicate or interrupt a first hydraulic chamber 65a and a tank by switching by the operation of the armature 64.

The solenoid-operated valves 10, 20, 30, 40, 50, 60 of the first to fifth embodiments use a hydraulic pressure but may use another fluid or an air pressure.

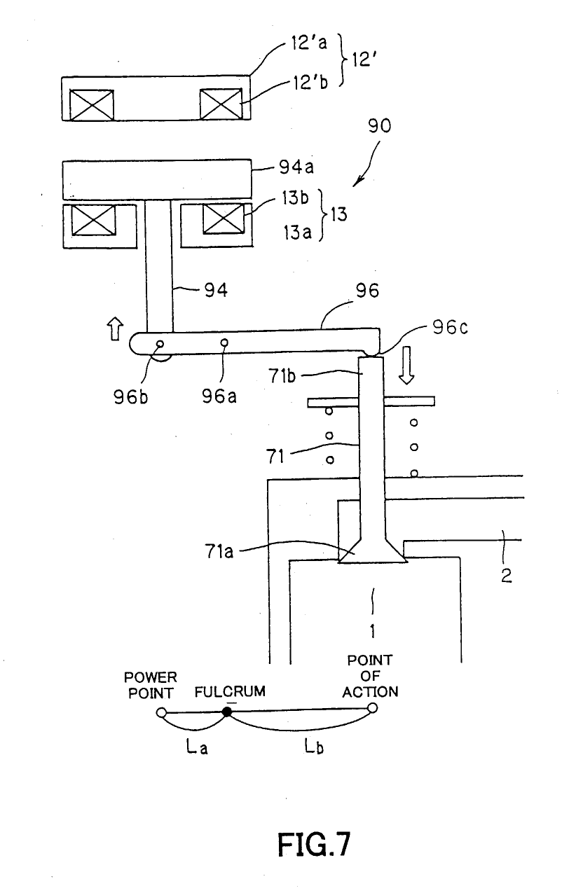

In the first to fifth embodiments, the solenoid-operated valve using the hydraulic pressure were described. But, solenoid-operated valves 90, 70 using a linkage will be described in the sixth and seventh embodiments. A basic embodiment of the solenoid-operated valve using the linkage is shown in FIG. 7.

FIG. 7 is a structure diagram showing the solenoid-operated valve 90 according to the sixth embodiment of the present invention. The solenoid-operated valve 90 shown in FIG. 7 is in a valve-closed state. Like reference numerals are allotted to like components as those of the solenoid-operated valve 10 shown in FIG. 1.

The solenoid-operated valve 90 comprises electromagnets 12′, 13, a valve element 71, an armature 94 and a linkage 96.

The electromagnet 12′ comprises a disc-shaped magnetic substance 12′a and a circular ring coil 12′b which is disposed in the magnetic substance 12′a.

The linkage 96 has a main body-supported section 96a which is rotatably supported by the body of the solenoid-operated valve 90, an armature-supported section 96b which is rotatably supported by the armature 94 and a valve element-contacting section 96c which is in contact with a head 71b of the valve element 71. The armature-supported section 96b of the linkage 96 is movable in the operation direction (vertical direction in the drawing) and perpendicular direction (horizontal direction in the drawing) of the armature 94. The linkage 96 pivots about the main body-supported section 96a by the operation of the armature 94. When the armature-supported section 96b of the linkage 96 is pulled up by the upward movement of the armature 94, the main body-supported section 96a serves as a “fulcrum”, the armature-supported section 96b serves as a “power point”, and a contact between the head 71b of the valve element 71 and the valve element-contacting section 96c serves as a “point of action”. The respective points 96a to 96c of the linkage 96 are arranged in such a way that the “fulcrum” is positioned at the middle of the “power point” and the “point of action”, and a distance Lb between the “fulcrum” and the “point of action” is larger than a distance La between the “fulcrum” and the “power point”.

Then, an operation of the solenoid-operated valve 90 will be described with reference to FIG. 7.

When a current to the coil 12′b is interrupted and a current is flowing to the coil 13b, the valve element 71 is positioned at the upper stroke end. At this time, the lid 71a of the valve element 71 interrupts the combustion chamber 1 and the exhaust path 2.

When a current to the coil 13b is interrupted and a current is flowing to the coil 12′b, the armature 94 is moved upward. The armature-supported section 96b moves upward together with the armature 94 as the armature 94 moves upward. At this time, the linkage 96 pivots about the main body-supported section 96a, and the valve element-contacting section 96c moves downward. Therefore, the valve element 71 is moved downward.

As shown in FIG. 7, when the distance Lb between the “fulcrum” and the “point of action” is larger than the distance La between the “fulcrum” and the “power point”, the displaced amount of the “point of action” becomes larger than that of the “power point”. Therefore, the displaced amount of the valve element 71 becomes larger than that of the armature 94. Meanwhile, a force smaller than the force of the “power point” acts on the “point of action”. Therefore, the driving force of the valve element 71 becomes smaller than that of the armature 94.

The solenoid-operated valve 90 can make a displaced amount of the valve element 71 larger than that of the armature 94 without flowing a large current, so that a gas intake port and a gas exhaust port have large open areas. And, the solenoid-operated valve 90 has a simple structure and its production cost can be reduced because it does not use a hydraulic pressure control device or the like.

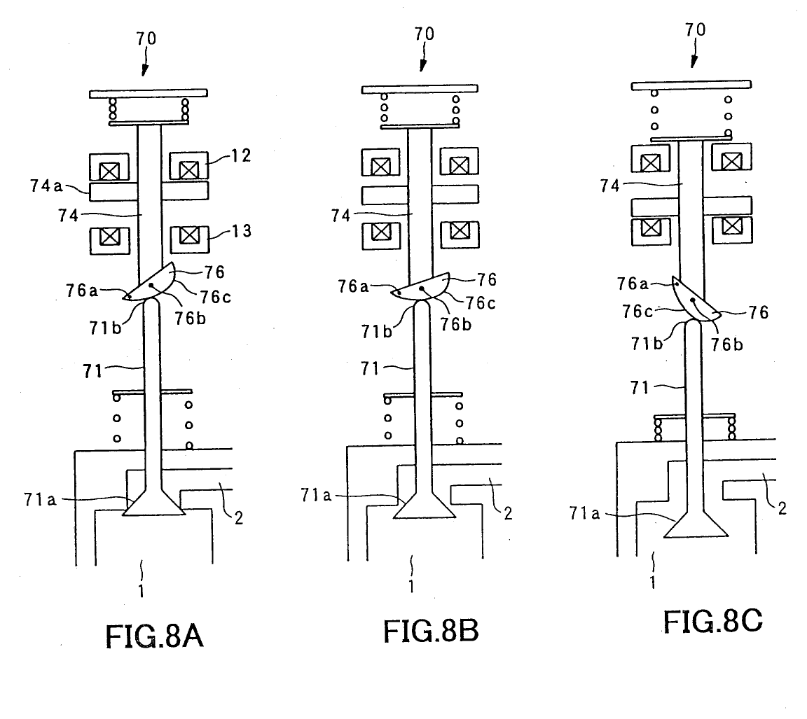

FIGS. 8A to 8C are structure diagrams showing a solenoid-operated valve 70 according to the seventh embodiment of the present invention. FIGS. 8A to 8C show sequentially a valve opening operation of the solenoid-operated valve 70. Like reference numerals are used for like components as those used for the solenoid-operated valve 10 shown in FIG. 1 and the solenoid-operated valve 90 shown in FIG. 7.

The solenoid-operated valve 70 comprises the electromagnets 12, 13, the valve element 71, an armature 74, and a linkage 76.

The linkage 76 has a main body-supported section 76a which is rotatably supported by the body of the solenoid-operated valve 70, an armature-supported section 76b which is rotatably supported by a tip of the armature 74, and an outer edge section 76c which comes into contact with the head 71b of the valve element 71. The armature-supported section 76b of the linkage 76 can be moved finely in the operation direction (vertical direction in the drawing) and perpendicular direction (horizontal direction in the drawing) of the armature 74. The linkage 76 pivots about the main body-supported section 76a by the operation of the armature 74. When the linkage 76 is pushed by the downward movement of the armature 74, the main body-supported section 76a becomes a “fulcrum”, the armature-supported section 76b becomes a “power point”, and a contact between the head 71b of the valve element 71 and the outer edge section 76c becomes a “point of action”. A positional relationship between the “fulcrum” and the “power point” of the linkage 76 does not change but the position of the “point of action” is varied by an operation of the armature 74.

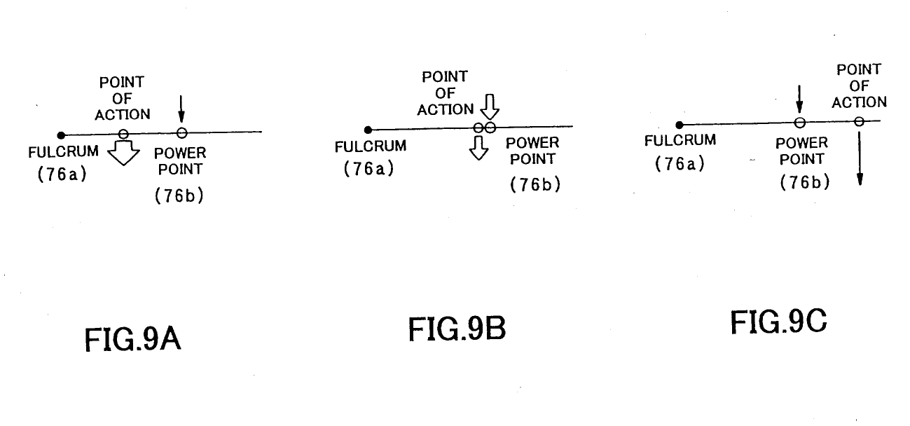

Then, the operation of the solenoid-operated valve 70 will be described with reference to FIGS. 8A to 8C and FIGS. 9A to 9C.

When a current to the coil 13b is interrupted and a current is flowing to the coil 12b, the valve element 71 is positioned at the upper stroke end. At this time, the lid 71a of the valve element 71 interrupts the combustion chamber 1 and the exhaust path 2. The head 71b of the valve element 71 is positioned at a part close to the main body-supported section 76a in the sliding range of the outer edge section 76c. This state is shown in FIG. 8A.

FIG. 9A is a diagram showing the “fulcrum”, “power point” and “point of action”, which are in the state of FIG. 8A, on the same linear line by projecting them in the operation direction of the valve element. As shown in FIG. 9A, the “point of action” is positioned between the “fulcrum” and the “power point” when they are in the state as shown in FIG. 8A.

When a current to the coil 12b is interrupted and a current is flowing to the coil 13b, the armature 74 is moved downward. The linkage 76 is moved downward while rotating about the main body-supported section 76a as the armature 74 moves downward. Then, the head 71b of the valve element 71 is moved downward while sliding along the outer edge section 76c of the linkage 76. With the movement of the linkage 76, the contact between the head 71b of the valve element 71 and the outer edge section 76c separates gradually from the main body-supported section 76a. FIG. 8B shows a state that the linkage 76 operates, and the head 71b has reached substantially the middle of the operation range on the outer edge section 76c.

FIG. 9B is a diagram showing the “fulcrum”, “power point” and “point of action”, which are in the state shown in FIG. 8B, on the same linear line by projecting them in the operation direction of the valve element. As shown in FIG. 9B, the “point of action” in the state shown in FIG. 8B has moved toward the “power point” as compared with the state shown in FIG. 8A.

Besides, the linkage 76 is moved downward as the armature 74 moves downward. Then, the head 71b of the valve element 71 slides along the outer edge section 76c of the linkage 76, and the contact of the head 71b of the valve element 71 and the outer edge section 76c moves further away from the main body-support section 76a. Thus, the armature 74, the linkage 76 and the valve element 71 are moved to reach the stroke ends. This state is shown in FIG. 8C.

FIG. 9C is a diagram showing the “fulcrum”, “power point” and “point of action”, which are in the state shown in FIG. 8C, on the same linear line by projecting them in the operation direction of the valve element. As shown in FIG. 9C, the “point of action” is outside of the “fulcrum” and the “power point” in the state shown in FIG. 8C.

It is apparent from FIGS. 9A, 9B that in the first half of the valve opening operation range of the valve element 71, the contact between the “point of action”, namely the head 71b of the valve element 71, and the outer edge section 76c, is between the “fulcrum”, namely the main body-supported section 76a, and the “power point”, namely the armature-supported section 76b. When the “point of action” is between the “fulcrum” and the “power point”, the displaced amount of the “point of action” becomes smaller than that of the “power point”. Therefore, the displaced amount of the valve element 71 becomes smaller than that of the armature 74. Meanwhile, a force larger than the force of the “power point” acts on the “point of action”. Therefore, the driving force of the valve element 71 becomes larger than that of the armature 74.

It is seen from FIGS. 9B and 9C that in the second half of the valve opening operation range of the valve opening operation, the contact between the “point of action”, namely the head 71b of the valve element 71, and the outer edge section 76c is outside of the “power point”, namely the armature support section 76b as viewed from the “fulcrum”, namely the main body-supported section 76a. When the “point of action” is outside of the “power point” as viewed from the “fulcrum”, the displaced amount of the “point of action” becomes larger than that of the “power point”. Therefore, the displaced amount of the valve element 71 becomes larger than that of the armature 74. Meanwhile, a force smaller than the force of the “power point” acts on the “point of action”. Therefore, the driving force of the valve element 71 becomes smaller than that of the armature 74.

The solenoid-operated valve 70 can make the driving force of the valve element 71 larger than that of the armature 74 without flowing a large current when opening the valve with the high inside pressure of the combustion chamber 1, so that the opening operation of the valve element 71 can be performed smoothly. And the displaced amount of the valve element 71 can be made larger than that of the armature 74 without flowing a large current after the inside pressure of the combustion chamber 1 has decreased, so that the gas intake port and the gas exhaust port have large open areas. And, the solenoid-operated valve 70 has a simple structure and its production cost can be reduced because it does not use a hydraulic pressure control device or the like.

In the first to seventh embodiments, the armature is moved by the attraction of the electromagnet, but the armature may be moved by the repulsion of the electromagnet.

The present invention is not limited to be used for the internal combustion engines only. But, it is very effective when used for the internal combustion engines, and more especially for diesel engines for industrial machines.

What is claimed is:

1. A solenoid-operated valve, comprising:
a moving element which is operated by an electromagnetic force;
a valve element which performs an opening or closing operation according to the operation of the moving element; and
a displacement converting mechanism which increases or decreases a displaced amount of the valve element relative to a displaced amount of the moving element.

2. A solenoid-operated valve, comprising:
a moving element which is operated by an electromagnetic force;
a valve element which performs an opening or closing operation according to the operation of the moving element; and
a displacement converting mechanism which has a moving element-side piston connected to the moving element, a valve element-side piston connected to the valve element, and a pressure chamber into which the moving element-side piston and the valve element-side piston are inserted, and which differentiates between a pressure-receiving area of the moving element-side piston and a pressure-receiving area of the valve element-side piston to increase or decrease a displaced amount of the valve element relative to a displaced amount of the moving element.

3. A solenoid-operated valve, comprising:
a moving element which is operated by an electromagnetic force;
a valve element which performs an opening or closing operation according to the operation of the moving element; and
a displacement converting mechanism having a linkage pivotably disposed on the moving element, for applying a force to the valve element to thereby increases or decreases a displaced amount of the valve element relative to a displaced amount of the moving element.

4. A solenoid-operated valve, comprising:
a moving element which is operated by an electromagnetic force;
a valve element which performs an opening or closing operation according to the operation of the moving element; and
a force converting mechanism which has a moving element-side piston connected to the moving element, a valve element-side piston connected to the valve element, and a pressure chamber into which the moving element-side piston and the valve element-side piston are inserted, and which differentiates between a pressure-receiving area of the moving element-side piston and a pressure-receiving area of the valve element-side piston to increase or decrease a driving force of the valve element relative to a driving force of the moving element.

5. A solenoid-operated valve, comprising:
a moving element which is operated by an electromagnetic force;
a valve element which performs an opening or closing operation according to the operation of the moving element; and
a force converting mechanism having a linkage pivotably disposed on the moving element, for applying a force to the valve element to thereby increases or decreases a driving force of the valve element relative to a driving force of the moving element.
